(19) United States
(12) Patent Application Publication
(10) Pub. No.: US 2002/0032587 A1
(43) Pub. Date: Mar. 14, 2002

(54) Method and apparatus for notifying passengers of delay exception events in transit systems

(76) Inventor: Paul Bermel, Atlanta, GA (US)

Correspondence Address: KENNEDY, DAVIS & HODGE, LLP, 5 CONCOURSE PARKWAY, SUITE 900, ATLANTA, GA, 30328, US

(21) Appl. No.: 09/792,639

(22) Filed: Feb. 23, 2001

Related U.S. Application Data
(60) Provisional application No. 60/184,437, filed on Feb. 23, 2000.

(51) Int. Cl. G06F 17/60

(52) U.S. Cl. 705/5

(57) ABSTRACT

An apparatus (10) for advance notification to passengers (16) of transit system interruption events, in which a central controller (12) contains a database (14) of a plurality of transit itineraries for a plurality of passengers and a correlated database of transit system routes and schedules. An evaluator analyzes interruption events that cause delays to the schedules of the transit systems and determines which transit itineraries are affected by the interruption events. A communicator (21) communicates information from the central controller (12) to the passengers (16) having transit itineraries affected by the interruption events, so that the passengers may make alternate travel arrangements.

### TECHNICAL FIELD

The present invention relates to notification systems for transit systems. More particularly, the present invention relates to notification systems and methods for advance notice to transit system passengers of delays and exception events affecting the travel schedule of passengers.

### BACKGROUND OF THE PRESENT INVENTION

Mass transit systems, such as trains, busses, and airplanes, provide a regular means of transportation for a large percentage of the population, whether for short distance transportation, for commute such as for work or leisure, or for long distance travel. Both as more and more people move to rural areas or suburbs of large cities and as increasingly more distant locations become accessible to a growing number of the population, the use of mass transit will continue to increase.

However, transportation by mass transit remains problematic because of the often unreliability of arrival and departure times. Vehicles of mass transit may be delayed, for instance, because of inclement weather conditions, stalled vehicles, accidents, mechanical failures or damage to tracks or roadways. Historically, there has been no reliable means for notifying a person scheduled to travel by mass transit that a delay has occurred, thus resulting in a change to that person's arrival or departure time. In order for a person to be informed of such a delay prior to arriving at the mass transit system, that person must affirmatively contact the mass transit system to inquire as to whether a particular arrival or departure time is accurate. Such affirmative action on the part of a scheduled traveler is bothersome and time consuming.

Thus, it is seen that a need remains for a method through which the mass transit system, itself, can notify a person scheduled to travel by mass transit that a delay in travel has occurred which results in a change in that person's scheduled arrival or departure times. Accordingly, it is to the provision of such that the present invention is primarily directed.

### BRIEF DESCRIPTION OF THE DRAWINGS

FIG. 1 is a schematic illustration of a notification apparatus for a transit system according to the present invention.

FIG. 2 is a schematic illustration of a route map for a transit system.

FIG. 3 is a data record of information for each passenger using the notification apparatus and method according to the present invention.

### DETAILED DESCRIPTION OF THE PRESENT INVENTION

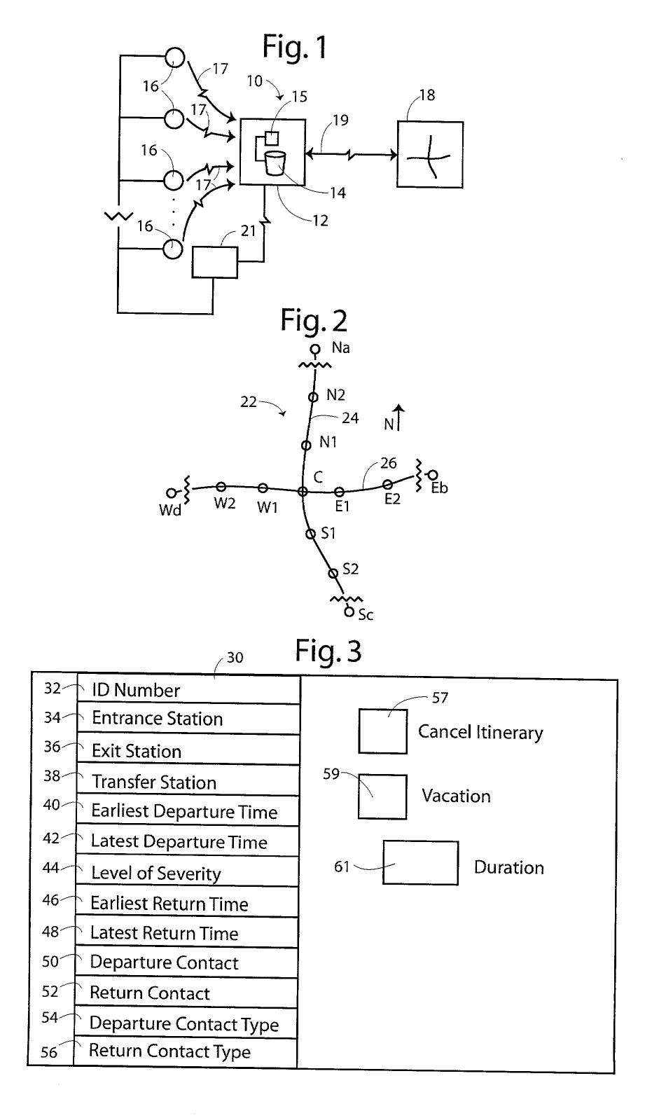

Referring now in more detail to the drawings, in which like numerals indicate like parts throughout the several views, FIG. 1 illustrates a schematic illustration of a notification apparatus 10 having a central computerized controller 12 with a database 14 of transit information provided by a plurality of passengers generally 16 of a transit system 18. Transit systems include aircraft services, ferrys, trains, passenger bus transit services, and other such transportation passenger conveying systems. Communication links generally 17 enable the passengers 16 to communicate with the controller 12. Communication links 19 enable the transit system 18 to communicate with the controller 12. Further, the controller 12 uses other communication links 21 for responding and reporting to the passengers 16, as discussed below. The apparatus 10 uses the passenger information in the database 14 and routing information 20 provided by the transit system 18 to advise the passengers of transit matters affecting the travel plans of the passengers, particularly of problems in the transit system that will cause delays or detours in travel using the transit system.

FIG. 2 is a schematic diagram of a route map 22 of a simple transit system 18 for purposes of illustrating features of the present invention. The example transit system 18 has a North-South line 24 and an East-West line 26, which connect at a central station C. Each line has one or more stations 28. The stations served by the transit vehicles of the system 18 are designated in FIG. 2 by a directional indicator and a numerical indicia. The directional indicator indicates the location of the station relative to the central station C. The directional indicators are N—North, E—East, S—South, and W—West. The numerical indicia is the sequential count of the station from the central station C along the respective directional line, and the stations identified as Na, Eb, Sc, and Wd, indicates the last station in the direction, where a, b, c, and d are the respective numerical indicia of the last station in the directional line.

FIG. 3 is schematic illustration of a data record 30 maintained in the database 14 with information for each passenger 16 using the notification apparatus 10 according to the present invention. The data record 30 includes an identification number 32 which is uniquely associated with a particular passenger 16. In an alternate embodiment, the passenger 16 may also enter a unique name for the particular itinerary, for example, MF Commute (for Monday-Friday Commute), Sat Golf (for Saturday golf travel), and the like. The passenger 16 provides his travel itinerary for the origination travel and the return travel using the transit system 18. The travel itinerary includes an entrance station 34 at which the passenger enters the transit system 18 for travel, an exit station 36 at which the passenger departs the transit system, and a transfer station 38 if used. The entrance station 34, the exit station 36, and the transfer station 38, are each identified by a unique station code, such as the coding N1, N2, S1, and so forth discussed above with respect to FIG. 2.

The passenger 16 also provides travel time information. This includes an earliest departure time 40 and a latest departure time 42. In the illustrated embodiment, the passenger 16 also provides a level of severity of delay 44 for which the passenger wants to be notified. The system permits a plurality of level designation 44 with differing estimated duration of delay. For example, four levels are provided in one embodiment of the invention:

Level 1 notify passenger of all delays

Level 2 notify passenger for delay estimated to be up to 20 minutes duration

Level 3 notify passenger for delay of 20 minutes to 1 hour duration

Level 4 notify passenger for delay of greater than 1 hour durations.

The passenger 16 thereby selects to be notified for delays depending on the duration of tolerable delays or interruptions. In an alternate embodiment, the passenger also enters the duration of transit system occupancy once the passenger has commenced travel during the earliest and latest departure times. However, duration is not necessary for practice of the present invention. The passenger 16 also provides an earliest return time 46 and a latest return time 48. These times reflect the period of time during which the passenger 16 expects to be traveling the return trip from the exit station 36 to the entrance station 34.

The passenger 16 also provides a contact identifier for a communications receiver for the passenger for both the origination (departure contact 50) and the return (return contact 52), as well as an indicator 54, 56 as to the types of communication receivers involved. For example, the communication receiver may be a facsimile machine, a telephone, an electronic mail address on a global interactive network, a receiver/display device in a motor vehicle, or other device. The contact identifier in many cases is a telephone number at which the passenger 16 may be contacted for receiving audible information from the apparatus 10 as discussed below. For such, a text-to-voice converter is used for mechanical speech conveying the delay information. In addition, a pre-recorded message may concatenate a voice message with the text-converted message, such as providing a recorded pronunciation of a difficult word. The transit system operator can access the recording device to record a message particular to the outage or interruption for communication to the passengers 16.

With reference to FIG. 1, each passenger 16 participating in the notification program of the transit system 18 contacts the controller 12 to provide travel information to the database 14. In one embodiment, the transit system 18 maintains a web site accessed through an interactive computer network. The web site has a template that tracks the record 30 illustrated in FIG. 3. The template provides passenger-completed blanks, such as a form, which the passenger completes and submits to the controller 12. Each passenger is assigned a unique identifier 32, which information is maintained confidential by appropriate password and security mechanisms. In an alternate embodiment, the passenger selects his own unique identifier. Also, should the passenger forget the password, he can request the system to communicate the password by the selected contact identification (i.e., by telephone, facsimile, electronic mail, or the like). A template for establishing the identifier 32 for each passenger and for validating the passenger 16, such as by password, for making changes to the passenger's record 30 is not illustrated but is within the ordinary ability of one of skill in the art. For example, as shown in FIG. 3, the template also includes a field 57 for indicating that the itinerary is to be canceled so that the passenger 16 can be deleted from notification services. Another field 59 permits the passenger 16 to defer notification for a selected duration 61, such as for vacation.

In an alternate embodiment within the scope of the present invention is the creation of an itinerary record for a passenger who schedules a single trip, such as flight arrangements or travel by train or bus. In this embodiment, the travel reservation includes presentation of the template discussed above for the beginning travel and return travel dates and times, together with the contact information. Similarly, the purchase of a periodic travel voucher, such as a monthly travel card for a commuter transit rail or bus system, includes the presentation of the passenger template for entry of the notification information. This is provided to the seller of the travel voucher at the time of sale for recording information (such as sale at a transit station or kiosk) or to the passenger if the passenger is purchasing the voucher directly by an interactive computer network.

Needless to say, the passenger travel information 34, 36, 38, 40, 42, 44, 46, and 48, and the passenger's contact numbers 50, 52 are confidential and are handled appropriately by the apparatus 10. The controller 12 preferably validates the information submitted by the passenger, for example the station identification codes. Other verifications can be performed, such as whether information expected to be numerical is so and the numerical entry for departure and return times is based on a twenty-four hour clock (i.e., no time greater than 25 hours) and the like validations. The web site provides for changes to travel itineraries and deletions from the database 14.

The transit system 18 provides the controller 12 with information about the transit schedule which reflect the routine and expected operating conditions of the transit vehicles in the system. This includes the duration between transit vehicles, frequence of departures, durations between adjacent stations. The transit system 18 then also provides real-time exception information to the controller 12. Such real-time exception information includes scheduled outages for maintenance as well as emergency or trouble outages which occur from time to time. The transit system 18 identifies the transit lines 24, 26, the stations, the nature of the exception, the starting time of the exception, and the duration of the exception. For example, if a station is closed due to water pipe breakage, the relevant information is provided to the controller 12. The exception information as to delays, expected duration of delay, and interruptions, may be entered to the controller 12 by keyboard input, menu driven entry, or automatically by an interface with a centralized control system of the transit operator.

The controller 12 uses the exception information together with the passenger information in the database 14 to evaluate notification to affected passengers. The controller 12 includes an evaluator 15 for determining the delay, the routes or schedules affected, the level of severity of delay, and the particular passengers of the plurality of itineraries maintained by the controller 12. If a travel itinerary for a passenger 16 is within the exception duration, line, or station, the controller 12 contacts the passenger using the contact number 50, 52. The contact can be made to a facsimile machine, a message recorder, a personal data assistant computer apparatus with communication devices, a telephone, or other information receiving device. For telephone contacts, a text-to-voice converter provides a mechanical communication of the information. The contact to the passenger in the form selected by the passenger communicates to the passenger the nature of the problem or exception, so that alternate transit plans can be made. The controller 12 may also make recommendations as to alternate routes, re-routing of transit vehicles, or other itineraries and times for travel. The passenger can thereby minimize the impact of the exception on the travel of the passenger. This should also reduce the number of persons in the area of the exception problem which facilitates operational control in the area for resolving the problem.

The present invention provides a notification system for alerting passengers of a transit system to exceptional events that impact the travel plans of the passenger, so that the passenger can make alternate plans.

In another embodiment, the departure times 40, 42, and the return times 46, 48 can be designated based on the day of the week. In another embodiment, these times are designated for workdays and separately for weekends. Further, the system permits designating multiple levels of severity of delay or interruption of the itinerary.

It is thus seen that the present invention provides transit systems and passengers with notice of transit interruption events for making alternate travel arrangements. While this invention has been described in detail with particular reference to the preferred embodiments thereof, the principles and modes of operation of the present invention have been described in the foregoing specification. The invention is not to be construed as limited to the particular forms disclosed because these are regarded as illustrative rather than restrictive. Moreover, many modifications, variations and changes may be made by those skilled in the art without departure from the spirit and scope of the invention as described by the following claims.

What is claimed is:

1. An apparatus for advance notification to passengers of transit system interruption events, comprising:
a central controller containing a database of a plurality of transit itineraries for a plurality of passengers and a correlated database of transit system routes and schedules;
an evaluator for analyzing interruption events that cause delays to the schedules of the transit systems and determining which transit itineraries are affected by the interruption events;
a communicator for communicating information from the evaluator to the passengers having transit itineraries affected by the interruption events,
whereby the passengers are provided with advance information about the interruption for transit travel in order to make alternate arrangements.
